(19) United States
(12) Patent Application Publication
(10) Pub. No.: US 2014/0049516 A1
(43) Pub. Date: Feb. 20, 2014

(54) TOUCH PANEL

(71) Applicant: TACKTOTEK OY, Oulu (FI)

(72) Inventors: Mikko Olavi Heikkinen, Oulu (FI); Antti Johannes Keranen, Oulu (FI); Juha Heikki Salo, Littoinen (FI)

(73) Assignee: TACTOTEK OY, Oulu (FI)

(21) Appl. No.: 13/970,649

(22) Filed: Aug. 20, 2013

(30) Foreign Application Priority Data
Aug. 20, 2012 (GB) 1214771.6

(51) Int. Cl. G06F 3/042

(52) U.S. Cl. CPC G06F 3/042
USPC 345/175; 29/622

(57) ABSTRACT

A touch panel (10) includes a first planar substrate (30) for receiving tactile contact from one or more objects. The first planar substrate (30) is operable to guide light radiation (310) therein by total internal reflection (TIR), wherein electronic circuits (220) are provided to transmit and detect the light radiation (310) guided within the first planar substrate (30) and to detect spatial positions of the tactile contact (40) of the one or more objects by a corresponding disturbance in the light radiation (310) propagating within the first planar substrate (30). The electronic circuits (220) are implemented by way of printed and/or deposited electronic elements onto at least one of: a trim (200) of the touch panel (10), the first planar substrate (30), a second planar protective substrate (20) which is operable to provide protection to the electronic circuits (220).

### TECHNICAL FIELD

This invention relates to touch panels, namely to touch panels including an arrangement of sensors which enables spatial locations whereat tactile contacts onto the panels occur to be determined. Moreover, the embodiments described herein concern methods of manufacturing aforesaid touch panels. Furthermore, the present embodiments concern software products recorded on machine-readable data storage media, wherein the software products are executable upon computing hardware associated with aforesaid touch panels for processing measurement signals generated by the panels from which the spatial location whereat tactile contact onto the panels occurs.

### BACKGROUND

Touch screens are well known from contemporary mobile telephones (also known as “cell phones”) and also from portable navigation aids, for example as manufactured by Tom Tom and Garmin. Moreover, touch-screen computer monitors are also known and are manufactured by contemporary companies such as liyama, HP-Compaq, Dell, Acer, Elo and others; such monitors are expected to make devices such as computer mice ultimately redundant as input devices.

Many different approaches to implementing touch panels are known in the technical art. For example, in a published PCT patent application no. WO/2010/122233 (PCT/FI2010/050339, Applicant—Teknologian Tutkimuskeskus VTT), there is described a user input arrangement and related method of manufacture. The arrangement, for example implemented as a touch-screen or touch-pad, comprises a substrate, such as an optically substantially transparent flex film or a multilayer film. The substrate includes support electronic circuits for providing power, control and/or communications connection to further electronic components, a number of emitters and detectors arranged in respect of the substrate into contact with the support electronic circuits, for emitting and detecting light respectively, and a light-guide. The electronic circuits, emitters, detectors and light-guides are provided laminated onto the substrate such that the emitters and detectors are optically coupled to the light-guide. Properties of the light-guide include a refractive index of the light-guide material being selected, and the emitters and detectors being configured, so as to enable, when in use, total internal reflection (TIR) of propagating light to occur within the waveguide between the emitters and the detectors; recognition of touching is determined on a basis of a drop in TIR performance from the light received at the detectors. There is also described a related method of manufacturing the user input arrangement.

In a published PCT patent application no. WO/2010/046539 (PCT/FI2009/050852, Applicant—Valtion Teknillinen Tutkimuskeskus), there is described an arrangement for a touch-screen and a related method of manufacture. The arrangement is intended for use with a touch-screen. The arrangement includes a substrate, for example an optically substantially transparent film or a film defining a through-hole. The substrate comprises support electronic circuits, for example printed electronic circuits including a plurality of printed conductors, for providing power, control and/or communications connection to further electronic components. Moreover, the arrangement includes a plurality of emitters and detectors arranged on the substrate into contact with the support electronic circuits, for emitting and detecting light, respectively. A light-guide is arranged on the substrate, such that the emitters and detectors, and optionally at least a part of the support electronic circuits, are substantially immersed in the light-guide material. Properties of the light-guide material are such that include its refractive index being selected, and the emitters and detectors being configured, so as to enable, when in use, total internal reflection (TIR)-type propagation of light within the light-guide between the emitters and detectors. Recognition of a touch is determined on a basis of a drop (FTIR) in the TIR performance as determined from the detected light at the detectors. An associated method of manufacture is also described.

The aforementioned touch panels are complex to manufacture which potentially prevents them being widely employed for data input, for example to replace use of known input devices such as computer mice and similar pointing devices.

### SUMMARY

According to a first aspect of the present invention, there is provided a touch-panel as defined in appended claim 1: there is provided a touch panel including a first planar substrate for receiving tactile contact from one or more objects, wherein the first planar substrate is operable to guide light radiation therein by total internal reflection, wherein electronic circuits are provided to transmit and detect the light radiation guided within the first planar substrate and to detect spatial positions of the tactile contact of the one or more objects by a corresponding disturbance in the light radiation propagating within the first planar substrate, characterized in that the electronic circuits are implemented by way of printed and/or deposited electronic elements onto at least one of: a decorative trim of the touch panel, the first planar substrate, a second planar protective substrate which is operable to provide protection to the electronic circuits.

The invention is of advantage in that the touch panel is simpler and easier to manufacture, and thus potentially of lower cost in manufacture. The touch-panel is manufactured to a higher degree of integration, thereby potentially increasing its reliability and/or decreasing its weight

Optionally, the touch panel is implemented such that the electronic circuits have associated therewith a connector tail for enabling the electronic circuits to be coupled externally.

Optionally, the touch panel is implemented such that the electronic circuits are formed by at least one of: printing, vacuum sputtering, vacuum evaporation, aqueous deposition, electroplating, etching, amorphous semiconductor deposition, organic semiconductor deposition.

Optionally, the touch panel is implemented such that the electronic circuits are disposed substantially at a peripheral region of the first substrate when the touch panel is assembled. More optionally, the touch panel is implemented such that transmitter elements (tx1, tx2) of the electronic circuits are included at a first set of mutually-abutting peripheral edges of the first substrate, and wherein detector elements (rx1, rx2) of the electronic circuits are included at a second set of mutually-abutting peripheral edges of the first substrate. More optionally, the touch panel is implemented such that the transmitter elements and detector elements, for reducing an influence from ambient illumination external to the touch panel, are in operation at least one of: multiplexed, strobed.

Optionally, the touch panel is implemented such that the second planar substrate has a central hole therein.

Optionally, the touch panel is implemented such that the first planar substrate is fabricated from glass, and the second planar substrate is fabricated from a plastics material.

Optionally, the touch panel is implemented such that at least one of the first and second planar substrates have major planar surfaces which are substantially rectangular in form.

Optionally, the touch panel is implemented such that the panel is configured to operate when overlaid onto a pixel graphics screen.

According to a second aspect of the present invention, there is provided a method of manufacturing a touch panel pursuant to the first aspect of the invention, characterized in that the method includes:
(a) preparing a first planar substrate;
(b) printing and/or depositing a wiring configuration around at least a part of a peripheral region of the first planar substrate;
(c) attaching a connector tail to the part of the peripheral region of the first planar substrate;
(d) printing and/or depositing transmitter and detector elements (tx1, tx2, rx1, rx2) onto at least a part of the peripheral region of the first planar substrate; and
(e) attaching a second planar protective substrate onto the first planar substrate to provide protection to at least the peripheral region whereat the transmitter and detector elements (tx1, tx2, rx1, rx2) are implemented.

It will be appreciated that features of the invention are susceptible to being combined in various combinations without departing from the scope of the invention as defined by the appended claims.

### DESCRIPTION OF THE DRAWINGS

Embodiments of the present invention will now be described, by way of example only, with reference to the following diagrams wherein:

FIG. 1 is an illustration of an embodiment of a touch panel pursuant to one embodiment;

FIG. 2 is an illustration of the touch panel of FIG. 1, wherein printed electronic circuits are included at first to fourth peripheral edge regions of a substrate of the touch panel, wherein transmitters are included along the first and second mutually abutting orthogonal edge regions and corresponding detectors are included along the third and fourth mutually abutting orthogonal edge regions, wherein a protector substrate is also included to protect the printed electronic circuits;

FIG. 3 is an illustration of an illustration of a further embodiment of a touch panel pursuant to one embodiment, wherein the touch panel includes a first glass window substrate and a second planar protector substrate for abutting via a major planar surface thereof to a major planar surface of the first glass window substrate, wherein electronic circuits of the touch panel are printed onto the first glass window substrate;

FIG. 4 is an illustration of an illustration of a further embodiment of a touch panel pursuant to one embodiment, wherein the touch panel includes a first glass window substrate and a second planar protector substrate for abutting via a major planar surface thereof to a major planar surface of the first glass window substrate, wherein electronic circuits of the touch panel are printed onto the second planar protector substrate;

FIG. 5 is a cross-sectional illustration of an edge region of the touch panels of FIG. 1 to FIG. 4, wherein implementation of the electronic circuits is shown; and

FIG. 6 is a cross-sectional illustration of an edge region of a curved touch panel, wherein an implementation of electronic circuits for the curved touch panel is shown.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, the present embodiments are concerned with touch panels, wherein each touch panel includes first and second planar substrates: these substrates provide two-dimensional major planar surfaces. The first planar substrate is fabricated from a material, for example glass, which is substantially optically transparent and capable of operating as a waveguide to confine light propagation within boundaries defined by major planar surfaces of the first planar substrate; the light propagation is confined by way of total internal reflection (TIR) resulting from the first panel being surrounded by a medium having a significantly lower optical refractive index in comparison to that of the first planar substrate. Moreover, the second planar substrate can be a planar structure that is manufactured to overlay onto at least a peripheral edge region of the first planar substrate. At least one of the first and second planar substrates includes printing electronic circuits thereon which are operable to generate light radiation for propagating within the first substrate as aforementioned, and which are operable to receive light radiation which has propagated within the first substrate, and which are operable to process signals corresponding to the received light. When an object, for example a stylus or a human finger is held in contact with the first substrate, light propagating within the first substrate is disturbed which influences the light propagation as received by the electronic circuits. By printing the electronic circuits, rapid low-cost manufacture of the touch panel is feasible, whilst also providing a compact and reliable touch panel. The electronic circuits beneficially employ devices such as thin-film-transistors (TFT), OLEDs and printed metallic or amorphous semiconductor conductors. Organic electronics and so-called flexible electronics allow benefits of flexibility and cost effective manufacturing and versatile products. Beneficially, the second substrate, when attached to the first substrate, protects the electronic circuits from damage or degradation, for example from degradation due to exposure to ambient air and moisture. Beneficially, the electronic circuits include multiplexers, analogue-to-digital converters, a microcontroller unit, latches, memory buffers and similar necessary for operation of the touch panel.

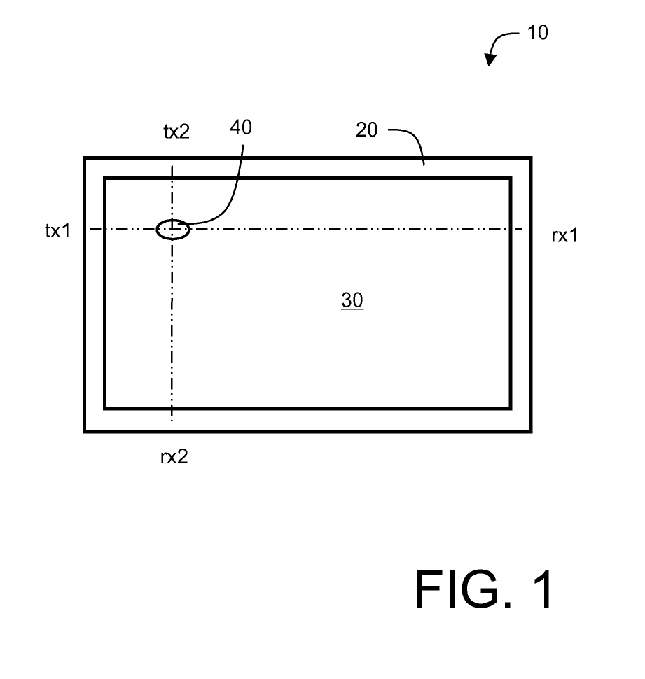

Referring to FIG. 1, there is shown an illustration of a touch panel indicated generally by 10. The touch panel 10 includes a first planar substrate 30, together with a second planar substrate 20 attached at least around a peripheral region of the first planar substrate 30 as illustrated. Light transmitters are denoted by t1, t2 that generate light rays which propagate within the first planar substrate 30 to corresponding detectors r1, r2 respectively. Beneficially, the light transmitters t1, t2 are included in first and second arrays of transmitters included substantially along first and second peripheral edge regions of the first planar substrate 30. Moreover, the light detectors r1, r2 are included in first and second arrays of detectors included substantially along third and fourth peripheral edge regions of the first planar substrate 30. Optionally, the first and third edge regions of the first planar substrate 30 are substantially parallel, and the second and fourth edge regions of the first planar substrate are substantially parallel. Optionally, the first to fourth edge regions are mutually orthogonal as illustrated, although the present embodiment is not limited to the first planar substrate being rectilinear in layout, namely the first planar substrate optionally has a more complex geometric shape, for example for more specialist niche uses, for example polygonal form, for example hexagonal form.

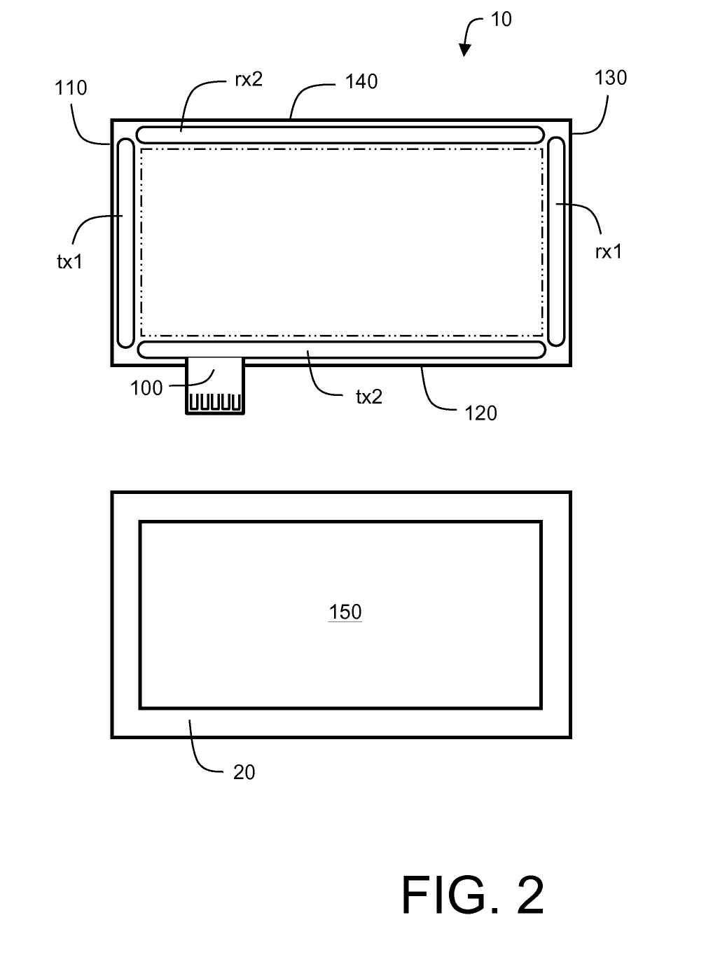

Details of manufacture of the touch screen 10 will now be described with reference to FIG. 2. The first planar substrate 30 is shown from top view, as seen by a given user when in use, wherein the first planar substrate 30 includes a peripheral attachment connector tail 100 for enabling an external electrical connection to be made to the electronic circuits incorporated into the touch panel 10. The first planar substrate 30 includes peripheral edge regions 110, 120, 130, 140. Optionally, the connector tail 100 is associated with the peripheral edge region 120 as illustrated. A first array of transmitting elements tx1 is printed along the peripheral edge region 110, wherein the elements tx1 corresponding to a plurality of spatially distributed light sources, for example implemented as organic light emitting diodes (OLED) or Zinc Oxide nano-wire type emitters, for example utilizing giant plasmon resonance phenomena for achieving highly efficient light emission. Optionally, the light radiation is infrared (IR) light radiation. In a similar manner to the first array tx1, a second array of transmitting elements tx2 is printed along the peripheral edge region 120. Moreover, a first array of detector elements rx1 corresponding to a plurality of spatially distributed light detectors is printed along the peripheral edge region 130, namely on an opposite side of the first planar substrate 30 relative to the peripheral edge region 110. Furthermore, a second array of detector elements rx2 corresponding to a plurality of spatially distributed light detectors is printed along the peripheral edge region 140, namely on an opposite side of the first planar substrate 30 relative to the peripheral edge region 120. A second planar protector substrate 20, for example implemented as a peripheral frame with a hollow central region 150, is included over the peripheral edge region 110 to 140 to protect the printed electronic circuits, for example to protect them from exposure to atmospheric Oxygen and moisture, and also from mechanical damage as a result of scratches and abrasive wear.

A method of manufacturing the touch panel 10 illustrated in FIG. 2 includes following fabrication steps:

STEP 1: preparing the first planar substrate 30 so that its surfaces are clean, and so that its internal material is capable of guiding light as aforementioned by way of total internal reflection;

STEP 2: forming connector tracks onto the first planar substrate 30 for receiving the connector tail 100; such forming is beneficially achieving using printing and/or deposition techniques, for example vacuum deposition techniques such as electrostatic deposition, spraying, sputtering or vacuum evaporation of metal, ambient electrostatic deposition, aqueous deposition, electroplating, or any combinations of such processes;

STEP 3: attaching the connector tail 100 to the connector tracks formed in STEP 2; the connector tail 100 is beneficially implemented as a flex foil, for example as selectively-metalized multilayer Kapton (trade mark) (polyimide) film assembly;

STEP 4: printing and/or depositing the transmitters tx1 , tx2 and detectors rx1 , rx2 onto the first planar substrate 30 in a manner so that they connect to the connector tracks associated with the connector tail 100; such forming is beneficially achieving using printing and/or deposition techniques, for example electrostatic deposition, spraying, vacuum deposition techniques such as sputtering or vacuum evaporation of metal, ambient electrostatic deposition, aqueous deposition, electroplating, or any combinations of such processes; optionally, polysilicon and/or amorphous Silicon is employed when fabricating the transmitters tx1, tx2 and detectors rx1, rx2 onto the first planar substrate 30; and

STEP 5: attaching the second planar protector substrate 20 onto the first planar substrate 30, for example using suitable bonding adhesives, so that components printed, deposited and/or attached in STEPS 2 to 4 are protected to the second planar protector substrate 20.

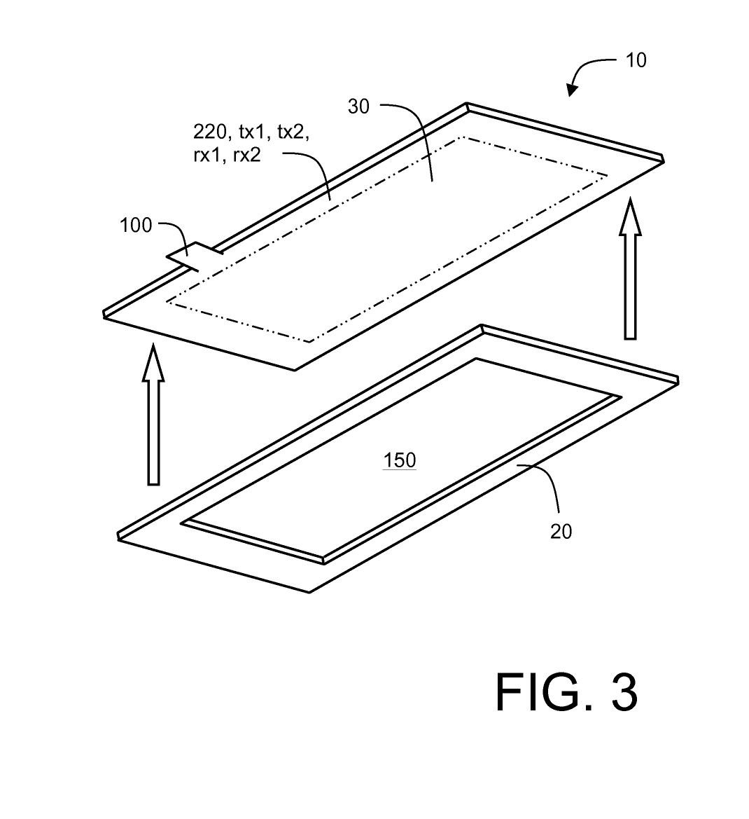

Referring next to FIG. 3, the first planar substrate 30 is shown including its electronic circuits (tx1 , tx2, rx1, rx2, 100) denoted by 220 implemented at a peripheral edge region of the first planar substrate 30. The second planar protector substrate 20 is then bonded onto the first substrate 30 such that the central hollow region 150 of the second substrate 20 allows user touch access, for example finger touch access, the a central region of the first planar substrate for influencing internal reflection of light propagating within the first substrate 30 in operation, thereby providing for input of user data, for example computer mouse or pointer control. Optionally, the second substrate 20 is fabricated from Silica glass and/or plastics materials (for example polyamide, polycarbonate or polymethyl methacrylate (PMMA)).

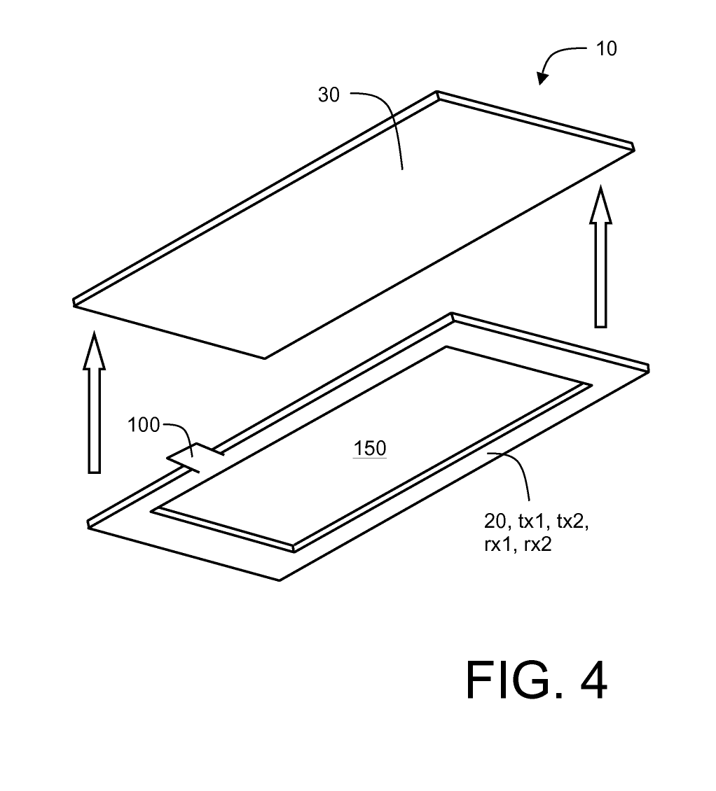

Referring to FIG. 4, it will be appreciated that the aforementioned electronic circuits, for example including the transmitters tx1, tx2, the detectors rx1, rx2 and the connector 100, are all formed onto the second planar protector substrate 20 as a complete assembly which is then added to the first planar substrate 30. Optionally, the second substrate 20 is manufactured from a robust flexible plastics material, for example polyamide, and the electronic circuits are formed from flexible materials, for example semiconducting polymeric materials; the first substrate 30 can then merely be a plane sheet of glass. Adding the second substrate 20 to the first substrate 30, for example by adhesive bonding, enables a touch panel 10 to be fabricated. Optionally, the first substrate 30 is overlaid, for example with a small air-gap region therebetween, onto a pixel display screen, for example a LCD (liquid crystal display) and/or OLED (organic light emitting diode) pixel screen, to enable such a pixel screen to have touch functionality, for example rendering use of mice and similar pointing devices in computer system redundant. Touch-screen personal-computer (PC) monitors and similar are capable of being manufactured thereby.

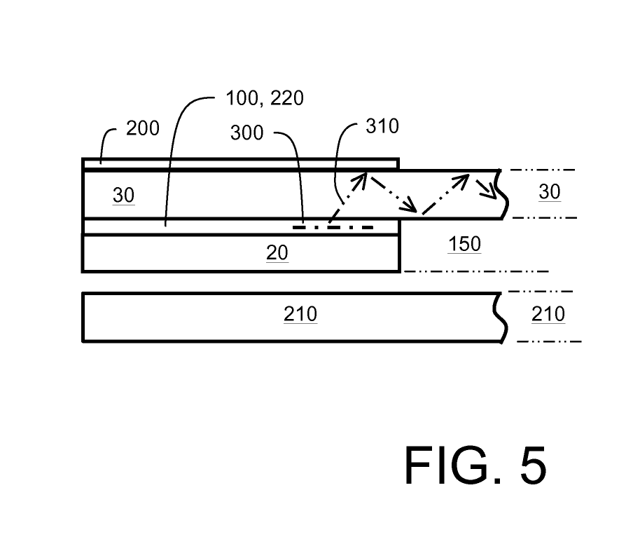

Referring next to FIG. 5, there is shown a cross-sectional illustration of a peripheral edge region of the touch panel 10. Beneficially, the touch screen 10 is overlaid in use onto a pixel display 210, for example by way of OEM or retrofit component. There is included a peripheral decorative trim 200 to shield optically the peripheral edge region whereat the aforementioned electronic circuits 220 are accommodated onto at least one of the first planar substrate 30 and the second protective planar substrate 20. Moreover, the aforesaid electronic circuits 220, and at least a portion of the connector 100, are accommodated between the substrates 20, 30 as illustrated. Printed transmitter elements 300 are operable to emit rays of light radiation 310 which propagate by way of total internal reflection within major planar surfaces of the first substrate 30. Optionally, light emitted from the transmitters tx1, tx2, namely the transmitter elements 300, is strobed, and the detectors rx1, rx2 and their associated signal processing circuits are operable to detect and demodulate internally reflected light received thereat with respect to the strobe so that influences of ambient illumination around the touch panel 10 are reduced.

Optionally, major planar surfaces of the first substrate 30 are patterned, for example with periodic grating features whose physical size is of a similar order to a wavelength of the light radiation 310 propagating within the first substrate 30, for example by way of shallow photo-etching or by additive printing processes, to cause the rays of light radiation 310 to propagate preferably in orthogonal general directions within the first substrate 30 by way of total internal reflection (TIR), so that the electronic circuits 220 of the touch panel 10 receive signals from the detectors rx1, rx2 which are more straightforward to decode in respect of determining one or more spatial positions on one or more major surfaces of the substrate whereat tactile contact of an object, for example a given user's finger or pointing stylus, has occurred.

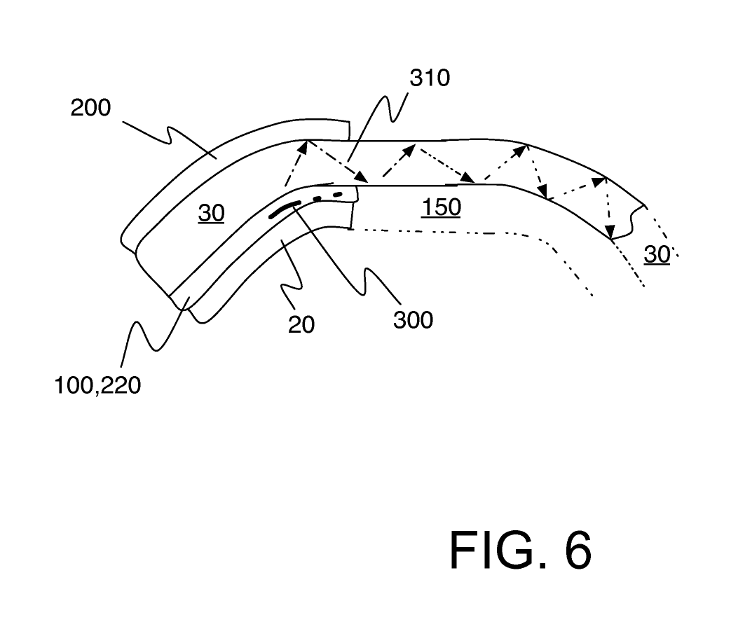

According to an embodiment, the touch panel can be curved as shown in FIG. 6. In this embodiment, the first substrate 30 is implemented to have a curved surface, and second substrate 20 is beneficially correspondingly curved to interface mechanically to the first substrate 30, for example there can be concave or convex surfaces involved. The touch panel thus provides a structure, which is optionally implemented in a top portion of an object such as a computer mouse, or other curved surface of an apparatus, or to manufacture a curved touch panel.

According to an alternative embodiment, the aforementioned electronic circuits, for example including the transmitters tx1, tx2, the detectors rx1, rx2 and the connector 100, can be formed onto a peripheral decorative trim 200. The peripheral decorative trim and the electronic circuits can be then connected to the second planar protector substrate 20 or to the first planar substrate 30 as a complete assembly.

According to an alternative embodiment, the first substrate 30, the second substrate 20 and the decorative trim 200 are manufactured from a flexible material to enable the resulting touch panel to provide a tactile sensor element present in a curved surface.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A touch panel (10) including a first planar substrate (30) for receiving tactile contact from one or more objects, wherein the first planar substrate (30) is operable to guide light radiation (310) therein by total internal reflection (TIR), wherein electronic circuits (220) are provided to transmit and detect the light radiation (310) guided within the first planar substrate (30) and to detect spatial positions of the tactile contact (40) of the one or more objects by a corresponding disturbance in the light radiation (310) propagating within the first planar substrate (30), wherein the electronic circuits (220) are implemented by way of printed and/or deposited electronic elements onto at least one of: a decorative trim (200) of the touch panel (10), the first planar substrate (30), a second planar protective substrate (20) which is operable to provide protection to the electronic circuits (220).

2. A touch panel (10) as claimed in claim 1, wherein the electronic circuits (220) have associated therewith a connector tail (100) for enabling the electronic circuits (220) to be coupled externally.

3. A touch panel (10) as claimed in claim 1, wherein the electronic circuits (220) are formed by at least one of: electrostatic deposition, spraying, printing, vacuum sputtering, vacuum evaporation, aqueous deposition, electroplating, etching, amorphous semiconductor deposition, organic semiconductor deposition.

4. A touch panel (10) as claimed in claim 1, wherein the electronic circuits (220) are disposed substantially at a peripheral region of the first substrate (30) when the touch screen (10) is assembled.

5. A touch panel (10) as claimed in claim 4, wherein transmitter elements (tx1, tx2) of the electronic circuits (220) are included at a first set of mutually-abutting peripheral edges of the first substrate (30), and wherein detector elements (rx1, rx2) of the electronic circuits (220) are included at a second set of mutually-abutting peripheral edges of the first substrate (30).

6. A touch panel (10) as claimed in claim 5, wherein the transmitter elements and detector elements, for reducing an influence from ambient illumination external to the touch panel (10), are in operation at least one of: multiplexed, strobed.

7. A touch panel (10) as claimed in claim 1, wherein the second planar substrate (20) has a central hole (150) therein.

8. A touch panel (10) as claimed in claim 1, wherein the first planar substrate is fabricated from glass, and the second planar substrate is fabricated from a plastics material.

9. A touch panel (10) as claimed claim 1, wherein at least one of the first and second planar substrates (20, 30) have major planar surfaces that are substantially rectangular in form.

10. A touch panel (10) as claimed claim 1, wherein the touch panel (10) is configured to operate when overlaid onto a pixel graphics screen (210).

11. A method of manufacturing a touch panel (10), comprising:
(a) preparing a first planar substrate (30);
(b) printing and/or depositing a wiring configuration around at least a part of a peripheral region of the first planar substrate (30);
(c) attaching a connector tail to the part of the peripheral region of the first planar substrate (30);
(d) printing and/or depositing transmitter and detector elements (tx1, tx2, rx1, rx2) onto at least a part of the peripheral region of the first planar substrate (30); and
(e) attaching a second planar protective substrate (20) onto the first planar substrate (30) to provide protection to at least the peripheral region whereat the transmitter and detector elements (tx1, tx2, rx1, rx2) are implemented.

12. A method of manufacturing a touch panel (10), comprising:
(a) preparing a second planar substrate (20);
(b) printing and/or depositing a wiring configuration around at least a part of a peripheral region of the second planar substrate (20);
(c) printing and/or depositing transmitter and detector elements (tx1, tx2, rx1, rx2) onto at least a part of the peripheral region of the second planar substrate (20); and
(e) attaching a first planar substrate (30) onto the second planar substrate (20) to provide protection to at least the peripheral region whereat the transmitter and detector elements (tx1, tx2, rx1, rx2) are implemented.

13. A method of manufacturing a touch panel (10), comprising:
(a) preparing a first planar substrate (30);
(b) printing and/or depositing a wiring configuration around at least a part of a peripheral region of a decorative trim (200);
(c) printing and/or depositing transmitter and detector elements (tx1, tx2, rx1, rx2) onto at least a part of the peripheral region of the decorative trim (200); and
(d) attaching the decorative trim (200) onto the first planar substrate (30) to provide protection to at least the peripheral region whereat the transmitter and detector elements (tx1, tx2, rx1, rx2) are implemented.
